(19) United States
(12) Patent Application Publication
(10) Pub. No.: US 2007/0101061 A1
(43) Pub. Date: May 3, 2007

(54) Customized content loading mechanism for portions of a web page in real time environments

(76) Inventors: Guruprasad Baskaran, Bangalore (IN); Kulvir S. Bhogal, Fort Worth, TX (US); Kanmani Nachimuthu, Houston, TX (US); Lakshmi N. Potluri, Austin, TX (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/260,578

(22) Filed: Oct. 27, 2005

(51) Int. Cl. G06F 12/00

(52) U.S. Cl. 711/118

(57) ABSTRACT

A system and method for associating blocks of Web page content with caching properties are provided. The caching properties may include global caching properties for all blocks of a Web page and/or individual caching properties for each individual block of the Web page. The caching properties may be identified within the code of the Web page content itself, such as within meta-tags. Caching properties may also be linked to client device characteristics. Both client device caching and proxy device caching of Web page content may be enabled, such that if a block of Web page content in the client device's cache is invalid, the proxy device's cache is checked for the block of Web page content. Thus, a single Web page may be rendered on a client device using blocks obtained from a local cache, a proxy device's cache, and blocks obtained from a source of the Web page content.

### BACKGROUND OF THE INVENTION

1. Technical Field

The present invention relates generally to an improved system and method for loading webpage content. More specifically, the present invention is directed to a system and method for customized content loading of portions of Web pages in real time environments.

2. Description of Related Art

The World Wide Web, a service of the Internet, has evolved from being a repository of static files (Hypertext Markup Language (HTML), Graphic Interchange Format (GIF) and the like) to a very dynamic system with Web sites that span the gamut of possibilities, from multi-media sites that broadcast music on demand to e-commerce Web sites linking consumers and businesses or businesses to other businesses. With this evolution in usage, there has been a corresponding change in the nature of the content served by Web sites. Indeed, an increasing number of Web pages served by Web sites, especially e-commerce Web sites and portals, are dynamically generated.

Generating Web pages on demand, in a dynamic fashion, is a very expensive operation, not only in terms of storage and processing time, but also ultimately in terms of money. The program or application logic that generates a dynamic Web page typically must access various data sources, user profile information and complex business rules to generate the Web page. Quite often, generating dynamic pages requires querying data from data-sources such as relational databases (catalog information), or processing information feeds (like a stock quote feed, for example), which add to the cost of page generation.

In an attempt to reduce the resources needed to service user requests and to better serve dynamic content, Web sites have resorted to caching. The premise underlying caching is that in many cases, the content of dynamically generated pages does not change very frequently, thereby allowing the accessed pages to be cached. The server caches (i.e. locally stores for later retrieval) copies of such dynamically generated Web pages. Conventionally, as shown in FIG. 1 at S11, a client sends a Hypertext Transfer Protocol (HTTP) request for a Web page by, for example, clicking on a hyperlink or by specifying a Universal Resource Locator (URL). As shown at S12, the HTTP request is then received by the server, which then checks its cache to see if the response to the request (the entire requested Web page) is stored in the cache, as shown at S13.

As called for by S18, if the requested page is indeed present in the cache and if the response page is still valid, the page is extracted from the cache and sent to the client, as shown at S17. If the entire requested page is not present in the cache or is present but invalid (stale), application logic and/or the Web page's script is executed, as shown at S14. Executing the application logic and/or script may require the server to access data sources such as databases or information feeds, as called for by step S15. Only thereafter may the requested Web page be dynamically generated and sent to the client, as specified in steps S16 and S17. A step of caching the just-generated full page in memory may also be carried out.

This mechanism works very well as long as the dynamically generated pages can be cached efficiently (i.e., they are not invalidated very frequently), and the cost of servicing the page from the cache is less than the cost of re-generating the page again. As a result of efficient caching, a Web server uses fewer resources, especially central processing unit (CPU) resources to service a client's HTTP request. The ability to cache and to efficiently retrieve cached pages improves the server's performance (reduced response time) as well as its capacity to acceptably accommodate a greater number of users than it would otherwise have been able to serve without resorting to caching.

This type of caching is termed “full page caching.” This terminology reflects the nature of this form of caching wherein the cache memory contains complete HTML responses, i.e. entire Web pages. Herein, an entire Web page corresponds to a single HTTP request. Note that this differs from a Web screen page displayed on a computer screen. Web screen pages may be composed of one or more Web pages independently requested by the logic that generates the display of Web screen pages on computer screens. Full page caching may improve a Web site's overall capacity to handle user traffic. However, this solution is limited in many cases, as the data sources for such dynamically generated pages may change very frequently or unpredictably, making it difficult to positively determine the current validity of the cached page.

In many cases, moreover, a Web page refers to more than one data source. Since the granularity of caching is the entire page, changes to data from any one of the data sources necessarily results in the invalidation of the entire page, even if the data originating from the other data sources has not changed. This problem is further exacerbated when one or more of the data sources changes very frequently. Indeed, if the Web page's data sources change very frequently, the cost of caching and frequently invalidating the cached entry may be greater than the cost of dynamically generating a new page to service each HTTP request. Because of these problems and the fear of serving stale pages, many Web sites have abandoned full page caching in favor of dynamically generating pages for each incoming request, despite the cost of doing so.

One solution to the problem of reducing the cost of providing dynamically changing Web content while avoiding the problems associated with full page caching is provided by Agrawal et al. in U.S. Patent Application Publication No. 2002/0004813. Agrawal et al. describes a system in which Web content, e.g., a Web page, is broken down into cacheable blocks of content in the code for the Web page, e.g., HTML. Each cacheable block of content has an associated caching properties including an expiration time and is treated as static data until it expires. Some blocks may have shorter or longer expiration times than other blocks. The caching properties are identified using a cache tag library in Java Server Pages (JSPs). In particular, special JSP tag extensions may be defined that allow application developers to specify the caching properties of the constituent blocks in a Web page.

It is important to note that the Agrawal et al. mechanism handles cacheable blocks in Web pages from the server side using JSPs, ASPs, or other server side scripting mechanisms. The cache properties of the blocks are used to maintain a server side cache memory, i.e. a cache memory that is directly accessible by the server but is not directly accessible by a client device.

With Agrawal et al. when a page is retrieved for the first time, a local copy of the content generated by each of the cached blocks is made in the server before passing the executed block on to the output stream to be assembled with the other constituent blocks into the requested Web page. This local copy may then be added to the server side cache and identified by a specific special tag attribute. During the subsequent retrieval of this page, the cached block in the server side cache may be retrieved from the server side cache, if it is still present therein. If one or more of the constituent blocks of the requested page are present in the server side cache, the retrieved block may be used to assemble the requested page if the cached block is still valid instead of redundantly re-executing the code to generate the block.

Thus, the caching attributes of cacheable blocks of a Web page are used by the mechanism of Agrawal et al. to control the generation of content to be placed on an output stream, i.e. a stream from the server to the client device. Accordingly, the caching attributes of the cacheable blocks of the Web page are established by the server application and/or Web page developers. There is no mechanism described for controlling client side caching of blocks of Web page content.

As mentioned above, the caching attributes of Agrawal et al. are not used to control a client side retrieval of content. It can be appreciated that server side caching of Web page content is a different matter from that of client side caching of Web page content. From the server perspective, caching simply involves determining whether the portion of content is present in the server side cache and is valid. If not, the portion of content is regenerated and placed in the server side cache. From the client side perspective, caching involves determining if the requested portion of content is present in the client side local cache and is valid and if not, sending a request for the Web content to an appropriate source of the content. When the Web content is received, a copy of the Web content may then be placed in a client side local cache for future requests.

Client side caching benefits the speed of retrieval even when the client retrieves pages from a server that does not utilize caching. Client side caching reduces the overload on the network since pages that are cached locally may be retrieved locally and a request need not be sent over the network. Server side caching benefits the speed of generation of Web content at the server side but has no benefit to the overload on the network.

Moreover, the caching attributes of Agrawal are fixed attributes that are applied regardless of the client device that receives the Web page. Thus, a first client device that may not have as many resources as a second client device will still have the same fixed caching attributes applied to the Web content retrieved by the first client device as to the Web content retrieved by the second client device. There is no ability to customize the caching performed, from a client side, based on the characteristics of the client devices themselves.

### SUMMARY OF THE INVENTION

In view of the above, it would be beneficial to have a system and method that permits customized loading of portions of Web page content in a real time system in which the loading is controlled from a client side. It would further be beneficial to have a system and method that provides customized loading of portions of Web page content based on characteristics of the client devices themselves. Moreover, it would be beneficial to have a system and method that permits a client side proxy device to provide a cache of portions of Web page content and mechanisms for determining when to provide requested Web page content from the client device cache, the proxy device cache, or to request the Web page content from the source of the Web page content.

The present invention provides a system, computer program product, and method for associating blocks of Web page content with caching properties. The caching properties may include global caching properties for all blocks of a Web page and/or individual caching properties for each individual block of the Web page. The individual caching properties may be different for each block of the same Web page. The caching properties may be identified within the code of the Web page content itself. In one exemplary embodiment, the caching properties may be provided as meta tags within the markup language code of Web page content.

In one exemplary embodiment, the caching properties identify a valid time period in which the corresponding block or blocks of Web page content are to remain valid within a client and/or proxy device cache. In another exemplary embodiment, such caching properties are linked to client device characteristics. For example, the manner by which blocks of the Web page content are cached may be made dependent upon the speed of the processor in the client device or other characteristics of the client device.

In an exemplary embodiment of the present invention, the meta tags may enable local caching of blocks of Web page content for various device formats. For example, various versions of a cached block of a Web page may be identified in the caching properties for handheld Web browsing devices, e.g., wireless telephones, handheld game devices, wristwatches, or any other type of device that may require a different format from that of a standard client computing device for which the Web page content was originally developed. Such local caching properties may include, for example, cache size attributes, display size attributes, different valid time periods for different types of devices, and the like. Such local caching in different formats for different devices provides for quicker retrieval of Web page content that is already formatted in the correct format for the particular device.

In the exemplary embodiments of the present invention, the caching of Web page content is controlled by a client device or a proxy device when parsing and executing the code of the Web page. In an exemplary embodiment of the present invention in which both client device caching and proxy device caching of Web page content is enabled, if a block of Web page content in the client device's cache is invalid, the proxy device's cache is checked for the block of Web page content. If the block of Web page content is valid in the proxy device's cache, then the block of Web page content is retrieved from the proxy device's cache and provided to the client device, where it is placed in the client device's cache in accordance with the caching properties. In this way, a single Web page may be rendered on a client device using blocks obtained from a local client device cache, blocks obtained from a proxy device's cache, and blocks of Web page content obtained from a source of the Web page content.

Moreover, blocks of Web page content may be used to render other Web pages that may use the same blocks even if the other Web pages do not have block level caching of Web page content enabled. For example, a first Web page having blocks A, B, C and D, and which has block level caching enabled, may be received in a client device. As a result, the blocks A, B, C and D may be stored in a local cache. Subsequently, a second Web page may be requested by the client device that also includes a block that is common to the first Web page, e.g., block A. Even though the second Web page may not have block level caching enabled, intelligent processing in the client device may determine that block A is present in the local cache and utilize the locally cached block A to render the second Web page.

In addition to the above, the present invention provides a user interface for displaying the code associated with a Web page such that a user may select blocks of the code to which block level caching is to be applied. Moreover this user interface provides a convenient mechanism by which a user may designate the caching properties for individual blocks of code of a Web page. Through use of the user interface, block level caching property meta tags may be automatically generated and inserted into the code of the Web page.

In an exemplary embodiment of the present invention, a method, apparatus and computer program product are provided in which code for a portion of a first Web page is received, where the code breaks the portion of the first Web page into blocks of Web page content, and one or more of the blocks of Web page content have associated caching properties identified in the code. The code is parsed for the portion of the first Web page to identify the blocks of Web page content and their associated caching properties. Content data corresponding to the blocks of Web page content is cached, in a client side data processing system cache, based on the associated caching properties. At least two blocks of Web page content have different caching properties and at least two portions of content data corresponding to the at least two blocks of Web page content are cached using the different caching properties.

In addition to the above, a request may be received to retrieve a second Web page, different from the first Web page, wherein a first block of Web page content in the second Web page is the same as a second block of Web page content in the first Web page. A determination may be made as to whether a first portion of content data, corresponding to the first block of Web page content in the second Web page that is the same as the second block of Web page content in the first Web page, is present in the client side data processing system cache. The first portion of content data may be retrieved from the client side data processing system cache if the first portion of content data is present in the client side data processing system cache. The second Web page may be rendered using the first portion of content data retrieved from the client side data processing system cache.

Moreover, a determination may be made as to whether the first portion of content data is valid in the client side data processing system cache. A request for the first portion of content data may be made from a source computing device if the first portion of content data is not present in the client side data processing system cache or is not valid in the client side data processing system cache. The second Web page may be rendered on a client device using the first portion of content data requested from the source computing device.

The first Web page may have block level caching enabled and the second Web page may not have block level caching enabled. The client side data processing system cache may be a local cache of a client device. The client side data processing system cache may be a cache of a proxy device coupled to a client device that originated a request for the first Web page. The associated caching properties may have a conditional requirement that identifies an operational characteristic that is required before the caching property is applied to content data for the corresponding block of Web page content. The associated caching properties are provided in meta tags within the code of the portion of the Web page. The request to retrieve the second Web page may originate from a different client device than a client device that requested the first Web page.

In addition, a determination may be made as to whether the first portion of content data is present in a client side proxy device coupled to the client device if the first portion of content data is not present in the local cache of the client device. The first portion of content data may be retrieved from the client side proxy device if the first portion of content data is present in the client side proxy device. The second Web page may be rendered on the client device using the first portion of content data retrieved from the client side proxy device.

Furthermore, operational characteristic information may be retrieved for the client side data processing system and compared to conditional requirements. A determination may be made as to whether the caching property is to be applied to content data for the corresponding block of Web page content based on results of the comparison.

The computer program product of the present invention may comprise a computer usable medium having a computer readable program. The computer readable program, when executed on a computer, may cause the computer to perform the various operations described above. In addition, the apparatus according to one exemplary embodiment of the present invention comprises a processor, a memory coupled to the processor, and a cache storage coupled to the processor. The memory may contain instructions which, when executed by the processor, causes the processor to perform the various operations described above.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram illustrating a prior art mechanism for handling Web page content requests from a client device;

FIG. 2 is an exemplary block diagram of a network data processing system in which aspects of the present invention may be implemented;

FIG. 3 is an exemplary block diagram of a server computing device in which aspects of the present invention may be implemented;

FIG. 4 is an exemplary block diagram of a client computing device in which aspects of the present invention may be implemented;

FIG. 5 is an exemplary diagram illustrating examples of caching property tags in accordance with one exemplary embodiment of the present invention;

FIG. 6 is an exemplary diagram for illustrating an operation of the present invention based on caching properties provided as part of code for blocks of Web page content;

FIG. 7 is an exemplary diagram illustrating a series of operations for rendering Web page content on a client computing device in accordance with one exemplary embodiment of the present invention;

FIG. 8 is an exemplary diagram illustrating a graphical user interface through which block level caching may be enabled in accordance with one exemplary embodiment of the present invention;

FIG. 9 is a flowchart outlining an exemplary operation of the present invention when caching a block of Web page content; and

FIG. 10 is a flowchart outlining an exemplary operation of the present invention when rendering a block of Web page content on a client computing device.

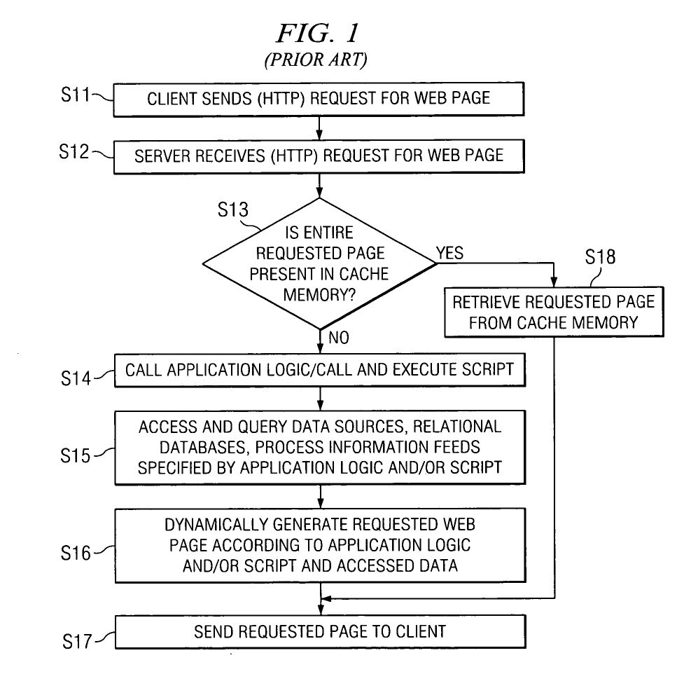

### DETAILED DESCRIPTION OF THE PREFERRED EMBODIMENTS

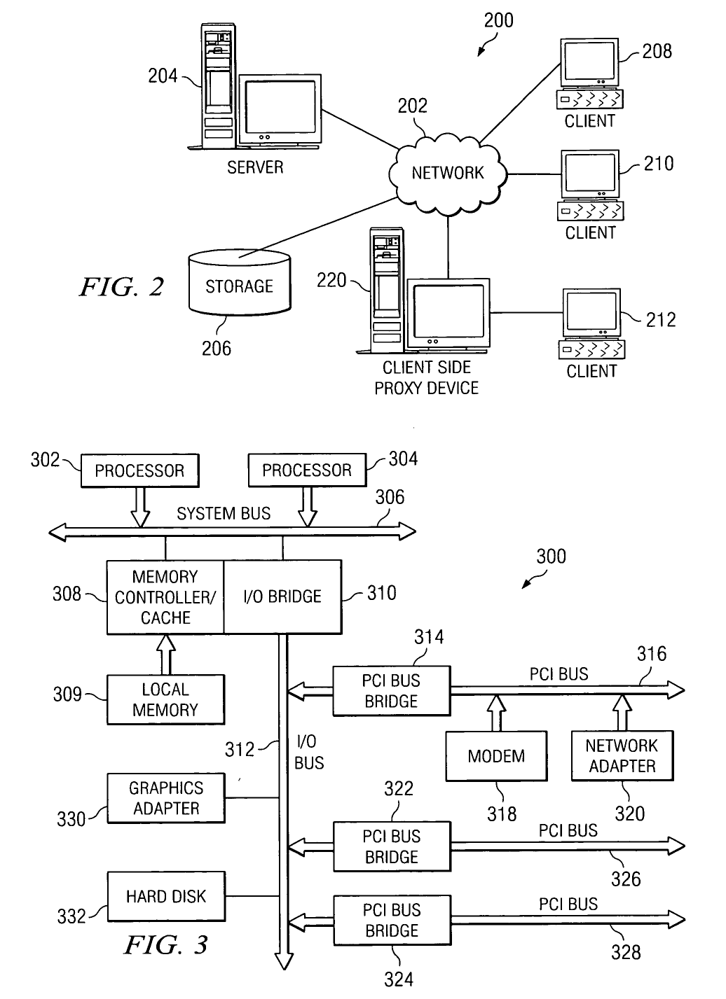

The present invention provides a mechanism for caching blocks of Web page content based on global and individual block caching properties identified in the code of the blocks of Web page content. As such, the present invention is especially well suited for distributed data processing environments, such as the Internet. The following FIGS. 2-4 are provided as exemplary of data processing environments and devices in which the aspects of the present invention may be implemented. The data processing environments and devices shown in FIGS. 2-4 are only exemplary and are not intended to state or imply any limitation as to the type or configuration of data processing environment or computing devices in which the aspects of the present invention may be implemented. Many modifications to the data processing environments and computing devices may be made without departing from the spirit and scope of the present invention.

With reference now to the figures, FIG. 2 depicts a pictorial representation of a network of data processing systems in which the present invention may be implemented. Network data processing system 200 is a network of computers in which the present invention may be implemented. Network data processing system 200 contains a network 202, which is the medium used to provide communications links between various devices and computers connected together within network data processing system 200. Network 202 may include connections, such as wire, wireless communication links, or fiber optic cables.

In the depicted example, server 204 is connected to network 202 along with storage unit 206. In addition, clients 208, 210, and 212 are connected to network 202. These clients 208, 210, and 212 may be, for example, personal computers or network computers. In the depicted example, server 204 provides data, such as boot files, operating system images, and applications to clients 208-212. Clients 208, 210, and 212 are clients to server 204. Network data processing system 200 may include additional servers, clients, and other devices not shown. In the depicted example, network data processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 200 also may be implemented as a number of different types of networks, such as for example, an intranet, a local area network (LAN), or a wide area network (WAN). FIG. 2 is intended as an example, and not as an architectural limitation for the present invention.

Referring to FIG. 3, a block diagram of a data processing system that may be implemented as a server, such as server 204 in FIG. 2, is depicted in accordance with a preferred embodiment of the present invention. Data processing system 300 may be a symmetric multiprocessor (SMP) system including a plurality of processors 302 and 304 connected to system bus 306. Alternatively, a single processor system may be employed. Also connected to system bus 306 is memory controller/cache 308, which provides an interface to local memory 309. I/O Bus Bridge 310 is connected to system bus 306 and provides an interface to I/O bus 312. Memory controller/cache 308 and I/O Bus Bridge 310 may be integrated as depicted.

Peripheral component interconnect (PCI) bus bridge 314 connected to I/O bus 312 provides an interface to PCI local bus 316. A number of modems may be connected to PCI local bus 316. Typical PCI bus implementations will support four PCI expansion slots or add-in connectors. Communications links to clients 208-212 in FIG. 2 may be provided through modem 318 and network adapter 320 connected to PCI local bus 316 through add-in connectors.

Additional PCI bus bridges 322 and 324 provide interfaces for additional PCI local buses 326 and 328, from which additional modems or network adapters may be supported. In this manner, data processing system 300 allows connections to multiple network computers. A memory-mapped graphics adapter 330 and hard disk 332 may also be connected to I/O bus 312 as depicted, either directly or indirectly.

Those of ordinary skill in the art will appreciate that the hardware depicted in FIG. 3 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 3 may be, for example, an IBM eServer pSeries system, a product of International Business Machines Corporation in Armonk, N.Y., running the Advanced Interactive Executive (AIX) operating system or LINUX operating system.

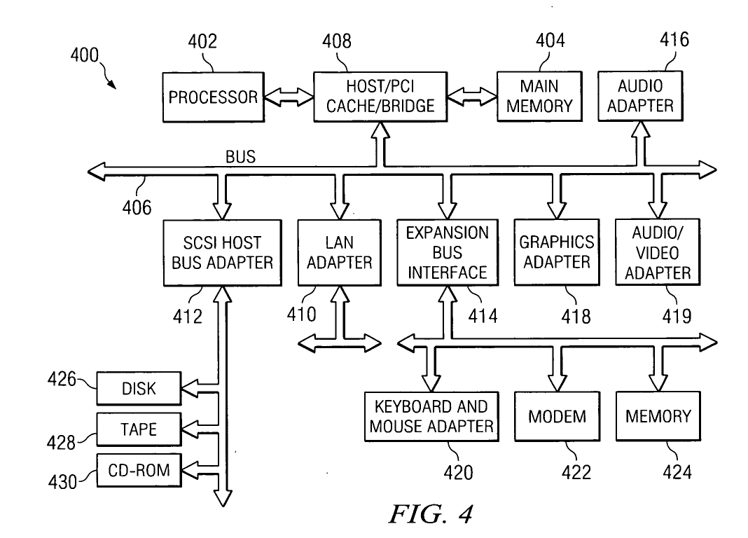

With reference now to FIG. 4, a block diagram illustrating a data processing system is depicted in which the present invention may be implemented. Data processing system 400 is an example of a client computer. Data processing system 400 employs a peripheral component interconnect (PCI) local bus architecture. Although the depicted example employs a PCI bus, other bus architectures such as Accelerated Graphics Port (AGP) and Industry Standard Architecture (ISA) may be used. Processor 402 and main memory 404 are connected to PCI local bus 406 through PCI Bridge 408. PCI Bridge 408 also may include an integrated memory controller and cache memory for processor 402. Additional connections to PCI local bus 406 may be made through direct component interconnection or through add-in boards.

In the depicted example, local area network (LAN) adapter 410, small computer system interface (SCSI) host bus adapter 412, and expansion bus interface 414 are connected to PCI local bus 406 by direct component connection. In contrast, audio adapter 416, graphics adapter 418, and audio/video adapter 319 are connected to PCI local bus 406 by add-in boards inserted into expansion slots. Expansion bus interface 414 provides a connection for a keyboard and mouse adapter 420, modem 422, and additional memory 424. SCSI host bus adapter 412 provides a connection for hard disk drive 426, tape drive 428, and CD-ROM drive 430. Typical PCI local bus implementations will support three or four PCI expansion slots or add-in connectors.

An operating system runs on processor 402 and is used to coordinate and provide control of various components within data processing system 400 in FIG. 4. The operating system may be a commercially available operating system, such as Windows XP, which is available from Microsoft Corporation. An object oriented programming system such as Java may run in conjunction with the operating system and provide calls to the operating system from Java programs or applications executing on data processing system 400. “Java” is a trademark of Sun Microsystems, Inc. Instructions for the operating system, the object-oriented programming system, and applications or programs are located on storage devices, such as hard disk drive 426, and may be loaded into main memory 404 for execution by processor 402.

Those of ordinary skill in the art will appreciate that the hardware in FIG. 4 may vary depending on the implementation. Other internal hardware or peripheral devices, such as flash read-only memory (ROM), equivalent nonvolatile memory, or optical disk drives and the like, may be used in addition to or in place of the hardware depicted in FIG. 4. Also, the processes of the present invention may be applied to a multiprocessor data processing system.

As another example, data processing system 400 may be a stand-alone system configured to be bootable without relying on some type of network communication interfaces As a further example, data processing system 400 may be a personal digital assistant (PDA) device, which is configured with ROM and/or flash ROM in order to provide non-volatile memory for storing operating system files and/or user-generated data.

The depicted example in FIG. 4 and above-described examples are not meant to imply architectural limitations. For example, data processing system 400 also may be a notebook computer or hand held computer in addition to taking the form of a PDA. Data processing system 400 also may be a kiosk or a Web appliance.

With the present invention, a server computing device, such as server 204 in FIG. 2, provides at least one portion of a Web page to a client device, such as client device 208. In accordance with the exemplary embodiments of the present invention, the server 204 provides a portion of Web page content that has associated caching properties. In a preferred embodiment, the portion of Web page content is either a single block of a Web page, or multiple blocks of a Web page. The Web page itself is made up of a plurality of blocks of Web page content which may all be provided by server 204 or may be provided by multiple servers or sources of Web page content.

In the depicted example, the server 204 provides a portion of Web page content directly to the client device 208 which may cache the portion of Web page content in a local cache of the client device 208 based on the associated caching properties of the portion of Web page content. In other embodiments of the present invention, a client side proxy computing device 220, such as a client side proxy server, may be provided through which the portion of Web page content may be provided to the client device 208. The term “client side” is meant to refer to the fact that the proxy device 220 is separated from the server 204 by a portion of a network 202, i.e. the proxy device 220 is not directly accessible by the server 204 and must be accessed via a network. The client device 208, however, may directly access the proxy device 220 without having to go through the network, although a local area network (not shown), different from the network 202 to which the server 204 is coupled, may be required for client device 208 to access the proxy device.

The client side proxy server 220 may itself cache the portions of Web page content based on the caching properties associated with the blocks of Web page content within the portions of Web page content. Multiple client devices may make use of the same client side proxy device 220 such that portions of Web page content requested by one client device, and cached in the proxy device 220, may be provided from the proxy device's cache to other client devices that request the same portion of Web page content.

As mentioned above, the present invention provides a system, computer program product, and method for associating blocks of Web page content with caching properties. The caching properties may include global caching properties for all blocks of a Web page and/or individual caching properties for individual block of the Web page. The individual caching properties may be different for each block of the same Web page. The caching properties may be identified within the code of the Web page content itself. In one exemplary embodiment, the caching properties may be provided as meta tags within the markup language code of the Web page content.

In one exemplary embodiment, the caching properties identify a valid time period in which the corresponding block or blocks of Web page content are to remain valid within a client and/or proxy device cache. In another exemplary embodiment, such caching properties are linked to client device characteristics. For example, the manner by which blocks of the Web page content are cached may be made dependent upon the speed of the processor in the client device or other characteristics of the client device.

In an exemplary embodiment of the present invention, the meta tags may enable local caching of blocks of Web page content for various device formats. For example, various versions of a cached block of a Web page may be identified in the caching properties for handheld Web browsing devices, e.g., wireless telephones, handheld game devices, wristwatches, or any other type of device that may require a different format from that of a standard client computing device for which the Web page content was originally developed. Such local caching properties may include, for example, cache size attributes, display size attributes, different valid time periods for different types of devices, and the like. Such local caching in different formats for different devices provides for quicker retrieval of Web page content that is already formatted in the correct format for the particular device.

In the exemplary embodiments of the present invention, the caching of Web page content is controlled on the client device and proxy device when parsing and executing the code of the Web page. In an exemplary embodiment of the present invention in which both client device caching and proxy device caching of Web page content is enabled, if a block of Web page content in the client device's cache is invalid, the proxy device's cache is checked for the block of Web page content. If the block of Web page content is valid in the proxy device's cache, then the block of Web page content is retrieved from the proxy device's cache and provided to the client device, where it is placed in the client device's cache in accordance with the caching properties. Since expiration times are keyed to the time at which the content data was sent by the content provider to the client/proxy device, the expiration time of the content data in the client device's cache will remain constant with the proxy device's cache in this case. In this way, a single Web page may be rendered on a client device using blocks obtained from a local client device cache, blocks obtained from a proxy device's cache, and blocks of Web page content obtained from a source of the Web page content, if necessary.

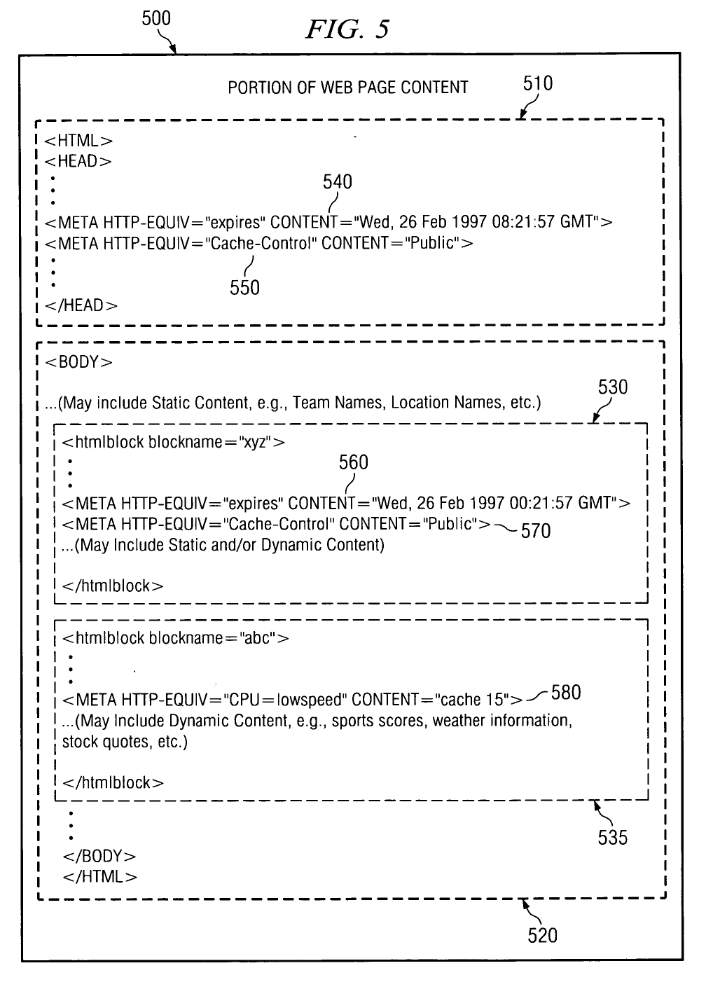

FIG. 5 is an exemplary diagram illustrating examples of caching property tags in accordance with one exemplary embodiment of the present invention. As shown in FIG. 5, the present invention provides a mechanism for providing caching properties in code of a portion of Web page content. In addition, as will be described in more detail hereafter, the present invention provides mechanisms for caching portions of Web page content on client devices and client proxy devices in accordance with these caching properties set forth in the code of the portion of Web page content. Moreover, the present invention provides mechanisms for controlling the retrieval of portions of Web page content at a client device based on such caching properties provided in the code of the portions of Web page content.

The example portion of Web page content depicted in FIG. 5 makes use of the HyperText Markup Language (HTML) as the language in which the portion of Web page content is coded. While the depicted example shows an HTML based portion of Web page content, the present invention is not limited to such. Rather, other programming languages, such as other markup languages including Extensible Markup Language (XML), Extensible HTML (XHTML), Standard Generalized Markup Language (SGML), and the like, may be used without departing from the spirit and scope of the present invention. The example code shown in FIG. 5 is only exemplary and is not intended to state or imply any limitation with regard to the manner by which caching properties may be provided in code of a portion of Web page content.

As shown in FIG. 5, the portion of Web page content 500 includes a header section 510 and a body section 520 that may include one or more blocks 530 and 535 of Web page content. Among other known header section elements of a portion of Web page content, the present invention provides meta tags 540, 550 for specifying global Web page level caching properties that identify the default caching properties for the entire portion of Web page content. These global, or default, caching properties are utilized by the client device and/or proxy device to cache blocks of the portion of Web page content 500 when separate individual block level caching properties are not specified for blocks of Web page content in the body 520 of the portion of Web page content 500. For example, if global caching properties are specified for the portion of Web page content, and block level caching properties are specified for a first block but not for a second block of the portion of Web page content, then block level caching properties will be applied to the first block of Web page content but global or default caching properties will be applied to the second block of Web page content.

Moreover, if there are conflicts between global and block level caching properties, such conflicts may be resolved in favor of one of block level or global caching properties, depending upon the particular implementation of the present invention. In a preferred embodiment of the present invention, global caching properties are preferred over block level caching properties when a conflict is identified.

The global or default caching properties are designated in meta tags 540 and 550 provided in the header section 510 of the portion of Web page content 500. The meta tags 540 and 550 specify such caching properties as cache control properties, cache control types, expiration times, expiration time period designations, cache size, network bandwidth, processor speed, and the like.

Similar meta tags are provided in the body section 520 of the portion of Web page content 500. These meta tags are provided at a block level within body section 520. That is, individual blocks of Web page content may be designated using tags, such as “htmlblock.” Each of these blocks of Web page content may have associated block level meta tags 560-580 for identifying caching properties associated with their corresponding block of Web page content. Some blocks may be designated within the body 520 of the portion of Web page content 500 but may not have associated block level caching properties specifically set forth in the code of the portion of Web page content 500. As a result, the global or default caching properties specified in the header section 510 would be applied to such blocks of Web page content when the client device and/or proxy device process the code of the portion of Web page content 500.

The meta tags 560 and 570 provide similar caching properties as those described above with regard to the global or default caching properties. That is, properties such as cache control properties, cache control types, expiration times, expiration time period designations, and the like, may be designated in block level meta tags 560 and 570. These caching properties supersede any global or default caching properties set forth in the header section 510 of the portion of Web page content 500, so long as a direct conflict between the two sets of caching properties is identified.

Meta tag 580 provides another example of a block level meta tag identifying block level caching properties that are slightly different from those of meta tags 560 and 570. The meta tag 580 shows an example in which the caching property includes a conditional requirement for the corresponding caching property to be implemented. The conditional requirement is based on a characteristic of the client device and/or proxy device that is processing the code of the portion of Web page content 500. For example, in the depicted example, the conditional requirement is that the CPU speed of the client device and/or proxy device be categorized as “lowspeed.” The actual determination as to whether a particular CPU speed is “lowspeed,” “middlespeed” or “high-speed” may be performed based on logic set forth in software and/or hardware provided in the client device and proxy device. For example, a plug-in module, applet, or other application, may be provided in association with a client device's browser, or in a proxy device, that makes such determinations and processes code of Web page content in accordance with the mechanisms of the present invention and the determined characteristics of the client device/proxy device.

It should be appreciated that while the depicted example bases the caching property on CPU speed, this is but one example of a client device and/or proxy device characteristic that may be used as a basis for determining whether to implement a caching property associated with a conditional requirement. Other examples may include network connection speed, cache size, available cache space, number of packets sent/received, or any other characteristic that is associated with the ability of the client/proxy device to receive and process data. Other characteristics that may be used include, for example, time of day, device type (e.g., handheld web browsing device), and the like. Any type of characteristic that is representative of the client/proxy device's ability to receive and process data is intended to be within the spirit and scope of the present invention.

Returning the depicted example, with the meta tag 580, when the CPU speed of the device processing the code of the portion of Web page content 500 is determined to be “lowspeed”, then the caching property “cache 15” is implemented on the device. In the depicted example, “cache 15” corresponds to caching the block of Web page content 535 for 15 minutes. Thus, an expiration time for the block of Web page content 535 may be established that is 15 minutes from a time at which the Web page content was originally transmitted by the content provider.

The body of each block of Web page content may provide code for rendering corresponding Web page content on a client device. Such code may reference sources of static and/or dynamic Web page content from which the content is to be retrieved. For example, dynamic Web page content that may be retrieved to provide a particular Web page on a client device includes stock quotes, sports scores, news stories, weather information, and the like. Each of these types of content may be provided from various sources, e.g., various content provider servers, which may be identified in the code of the block of Web page content.

When the code of the block of Web page content is processed by a browser application, or the like, on a client device, a separate request for that content is generated. This request is processed to determine whether to retrieve the content from its identified source, a local cache of the client device, a proxy device cache, or other source. With the present invention, when the request is processed, a local cache of the client device is first queried to determine if a valid copy of the content for the block of the Web page is present in the local cache. If not, and if a proxy device is provided, a proxy device cache is queried to determine if a valid copy of the content for the block of the Web page is present in the proxy device cache. If not, then the request is transmitted to the original source of the content for the block of the Web page so as to obtain the content for rendering the block of the Web page at the client device.

It is important to realize that each block of Web page content may have its own set of block level caching properties specified in meta tags associated with the block of Web page content. As a result, a single Web page may be comprised of a plurality of blocks of Web page content, each having different caching properties. Thus, when retrieving such a Web page, blocks of the Web page may be retrieved from a number of different places including a local cache of the client device, a cache in a proxy device, and various original sources of the blocks of Web page content. The processes for obtaining of content for rendering blocks of a Web page may be performed in substantially a parallel manner so as to build a rendition of the Web page on the client device from the various identified blocks of Web page content identified in the code of the Web page content.

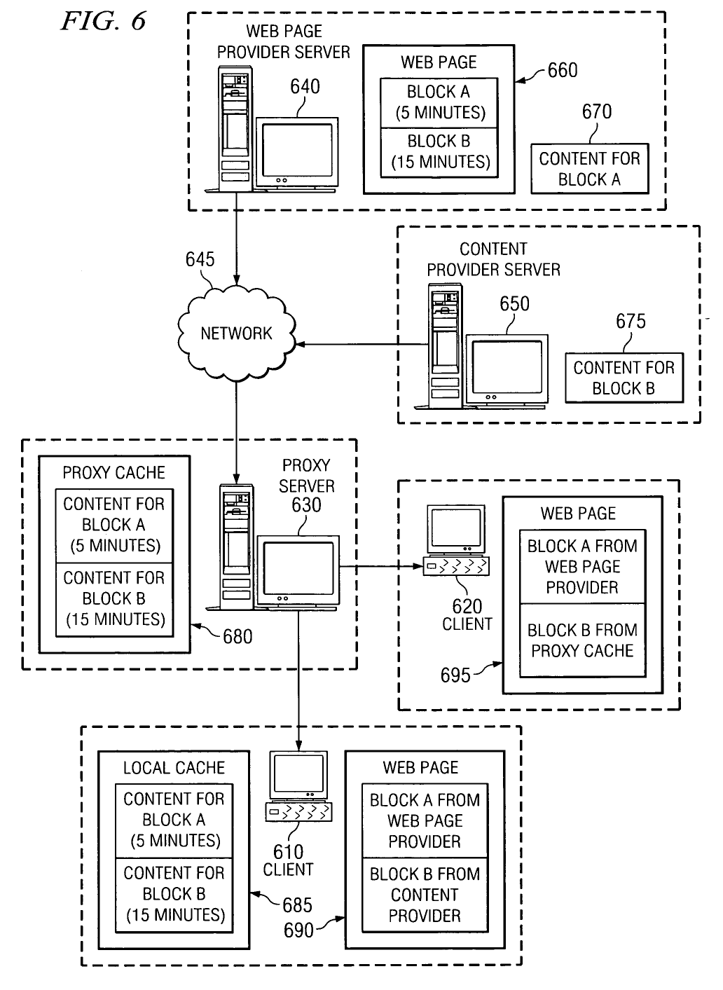

FIG. 6 is an exemplary diagram for illustrating an operation of the present invention based on caching properties provided as part of code for blocks of Web page content. The depicted example makes use of a proxy server through which the client devices access a network. The proxy server is not essential to the operation of the present invention but provides additional functionality as described hereafter. As set forth previously, the mechanisms of the present invention may be implemented in a distributed data processing system in which the client devices access web page provider and content provider systems directly via a network without a proxy server being interposed between the client devices and the network.

In the example shown in FIG. 6, it is assumed that a user of client device 610 has sent a request for a particular web page 660 using a browser application provided on the client device 610. As is well known in the art, such a request may be generated by the user entering, for example, a Uniform Resource Locator (URL) for the web page 660, clicking on a hyperlink for the Web page 660, or the like. The request is routed to the Web page provider server 640 via proxy server 630 and network 645 in a manner generally known in the art.

The Web page 660 includes two blocks of Web page content, block A and block B, which each have separate caching properties associated with them. For purposes of simplicity of the example, the caching properties are considered to be caching properties that are not dependent upon any client device characteristics. However, it will be readily understood that the caching properties may be based on characteristics of the client device 610 that is processing the Web page 660 code in the manner previously described, without departing from the spirit and scope of the present invention.

In response to receiving the request for the Web page 660, the Web page provider server 640 sends the Web page 660 to the client device 610 via the proxy server 630 and network 645. The proxy server 630 receives the Web page 660 and processes the code and data to determine how to cache the data in accordance with the caching properties specified in the code of the Web page 660.

For example, upon receiving the code for the Web page 660, the proxy server 630, by way of a running application, applet, plug-in, or hardware implemented logic, parses the code for the Web page 660, identifies meta tags associated with page level and block level caching properties, and processes content data for the blocks of the Web page 660 in accordance with the caching properties specified in the meta tags. Such processing may include the proxy server 630 requesting any required content data for blocks of the Web page 660 from content providers, such as the content data 670 for block A from server 640 and content data 675 for block B from content provider server 650. As a result of such operations, the proxy server 630 receives and stores the content data for blocks A and B of Web page 660 in proxy cache 680. The validity attributes for the content data of Block A are set such that the content data becomes invalid after 5 minutes from the time at which the content data was transmitted to the proxy server 630 from server 640. The validity attributes for the content data 675 of Block B are set such that the content data becomes invalid after 15 minutes from the time at which the content data was transmitted to the proxy server 630 from content provider server 650.

While the proxy server 630 is performing such caching operations, the web page 660 and content 670 are forwarded to the client device 610 that originated the request for the web page 660. The client device 610 performs similar caching operations based on the caching properties identified in the code of the web page 660. The client device 610 stores the content data 670 for block A in a local cache 685 and sets the validity attributes for the content data 670 for Block A so that the content data 670 becomes invalid after 5 minutes from the time it is received in the client device 610. The client device 610 may also issue a request for the content data 675 for block B to content provider server 650 and store the received content data 675 in local cache 685 with validity attributes set so that the content data 675 becomes invalid after 15 minutes from the time that it is received in the client device 610. In addition, the client device 610 may render the web page 690 on the client device using the content data for blocks A and B.

Assume that at approximately 10 minutes after the Web page content data is cached in the proxy cache 680, client device 620 issues a request for the same Web page 660 and that client device 620 also accesses network 645 via the proxy server 630. The code for Web page 660 is received by client device 620 from the Web page provider 640. Alternatively, the code may be provided to the client device 620 by proxy server 630, or from a local cache (not shown) if the Web page has been previously requested by the client device 620. The application, plug-in, applet, or the like, on the client device 620 parses the code of the Web page 660 and attempts to retrieve the content data for each of the blocks of Web page content.

For each block of Web page content, the client device 620 first looks at its own local cache to determine if the local cache stores a valid copy of the content data for rendering the block of Web page content. If not, then a request for content data for the block of the Web page content is sent to the proxy server 630. The proxy server 630 looks at its own proxy cache 680 to determine if it has a valid copy of the content data for the block of the Web page content. If not, then the request is forwarded to the appropriate content data provider, e.g., content provider server 650.

In the particular example shown in FIG. 6, the validity of the various blocks of Web page 660 is determined according to the caching properties specified in the code of the Web page 660 when it was originally received and stored in the cache, e.g. proxy cache 680 and client device local cache. Since neither block A nor block B have their content data stored in a local cache of client device 620, a determination is made as to whether the proxy server 630 has valid content data for these blocks in proxy cache 680.

Since the present request from client device 620 occurs 10 minutes after the time at which the content data for blocks A and B is transmitted to proxy cache 680, the content data for block A is invalid in proxy cache 680. However, the content data for block B in proxy cache 680 is still valid. As a result, the request for the content data for block A is forwarded to Web page provider server 640 to retrieve content data 670 and the content data for block B is sent from the proxy cache 680 to the client device 620. As a result, the client device 620 renders the web page 695 on client device 620 using the content data 670 for block A as obtained from the web page provider server 640 and the content data for block B from proxy cache 680.

It should be noted that in such a case, since the content data for block A was invalid in proxy cache 680, and had to be requested from web page provider server 640, this content data is again cached in proxy cache 680 with new validity attributes keyed to the most recent transmission of the content data by the web page provider server 640. This content data 670 and the content data for block B obtained from proxy cache 680 are also cached in a local cache (not shown) in client 620. The validity attributes for this content data will match those of the proxy cache 680 such that the content data will expire in both the client device 620 and the proxy device 630 at the same time. Relative to client device 610, the content data for block B in proxy cache 680 will expire at the same time as the copy of this same content data in local cache 685. However, the content data for block A will remain valid in proxy cache 680 even after the content data for block A in local cache 685 expires due to the subsequent request for the content data for block A made by client device 620.

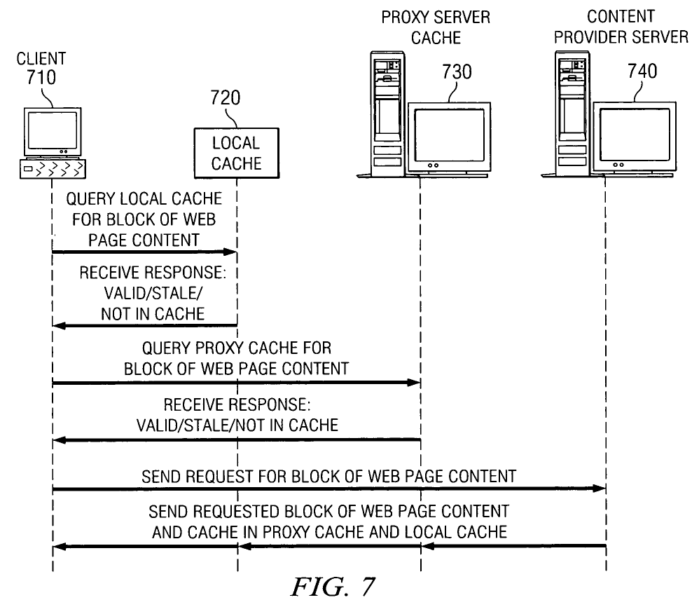

FIG. 7 is an exemplary diagram illustrating a series of operations for rendering Web page content on a client computing device in accordance with one exemplary embodiment of the present invention. As shown in FIG. 7, when a client device 710 receives a request to retrieve a Web page, such as by way of a user's entry of a URL or clicking of a hyperlink, for example, the client device 710 first queries its local cache 720 for the content to render the Web page in a browser application of the client device 710. For purposes of illustration, it will be assumed that the operation shown in FIG. 7 is performed for each block of Web page content within the requested Web page and thus, only a single block will be addressed in this description. The operations described may be repeated for each block of Web page content until all of the necessary content data for rendering the Web page at the client device 710 is made available to the client device 710.

The querying of the local cache 720 results in either the block of Web page content being within the local cache 720 and being valid, i.e. it has not expired, the block of Web page content being within the local cache 720 but being invalid, or the block of Web page content not being within the local cache 720. If the block of Web page content is within the local cache 720 and valid, then the response from the local cache 720 may include the content data for that block of Web page content, which the browser application may then use to render the Web page on the client device 710.

If either the block of Web page content is invalid within the local cache 720 or is not in the local cache 720, then the client device 710 queries the proxy server cache 730 for the content data corresponding to the block of Web page content. Again, the content data for the block may be in the proxy server cache 730 and valid, in the proxy server cache 730 and invalid, or not in the proxy server cache 730. If the content data for the block is in the proxy server cache 730 and is valid, then it is returned to the client device 710 for use in rendering the Web page. Moreover, the proxy server cache 730 may be refreshed again when the client device 710 uses the data stored in the proxy server cache 730. If the content data is either in the proxy server cache 730 and invalid or not in the proxy server cache 730, then the client device 710 sends a request to the content provider server 740 that is the source of the content data for that block of Web page content.

When the content provider server 740 sends the requested content data to the client device 710, the content data is passed through the proxy server. The proxy server performs the necessary operations, as previously discussed, to parse the caching property meta tags in the content and store a copy of the content data for the block of Web page content in the proxy server cache 730 in accordance with these caching property meta tags. A similar operation is performed at the client device 710 to store a copy of the content data for the block of Web page content in the local cache 720.

It should be noted that, because the present invention provides a client side block level caching mechanism, the performance gains obtainable from client side cached portions of a Web page may be achievable even if the Web page that is being requested does not enable block level caching. In other words, with the mechanisms of the present invention, intelligent logic may be provided in conjunction with the client side browser application, such as via a plug-in application, an applet, or the like, to analyze requested Web pages to determine what blocks of content are present in the Web pages that may be retrieved from a local cache or from a client side proxy cache device. Thus, blocks of Web page content which have been cached in a local cache or proxy device's cache may be used to render other Web pages that may use the same blocks even if the other Web pages do not have block level caching of Web page content enabled.

For example, a first Web page having blocks A, B, C and D, and which has block level caching enabled, may be received in a client device. As a result, the blocks A, B, C and D may be stored in a local cache and/or a proxy device's cache. Subsequently, a second Web page may be requested by the client device, or a different client device if a proxy device is utilized, that also includes a block that is common to the first Web page, e.g., block A. Even though the second Web page may not have block level caching enabled, intelligent processing in the client device may determine that block A is present in the local cache and utilize the locally cached block A to render the second Web page.

This intelligent processing may involve parsing and analyzing the code of the requested Web page to identify blocks within the code of the requested Web page. Searching a local cache and/or proxy device's cache to determine if the identified blocks are present and valid in either the local cache or the proxy device's cache and retrieving those cached versions of the Web page blocks if they are present and valid. If the blocks are not present, then the original source of that portion of Web page content may be accessed to obtain the requested Web page content. All of this processing may be performed despite the fact that the requested Web page itself does not enable block level client side caching of Web page content.

It should be noted that while the above embodiments are described in terms of the automatic caching of blocks of Web page content based on block level caching properties specified in the code of the Web page, such automatic caching may be overridden by the user of the client device. That is, the user may select an appropriate control to override block level caching when the user so desires. The control may take the form of a graphical user interface control that is selectable by the user via a user interface, a particular combination of key strokes, or the like. In such an instance where the user overrides block level caching, global caching properties may be utilized instead. Alternatively, if block level caching is overridden by the user, caching of the Web page content may be discontinued altogether.

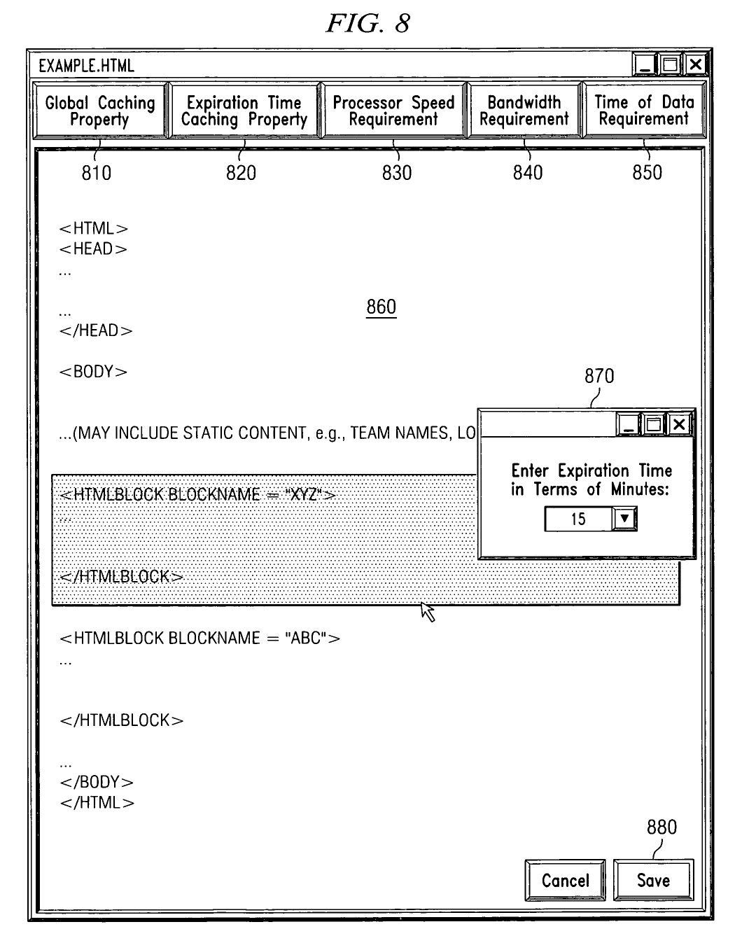

As mentioned above, the embodiments of the present invention make use of block level caching properties that are specified in the code of the Web page content. FIG. 8 is an exemplary diagram illustrating a graphical user interface through which block level caching may be enabled in accordance with one exemplary embodiment of the present invention. As shown in FIG. 8, the graphical user interface includes a plurality of tool interfaces 810-850 for specifying different types of global and/or block level caching properties. A Web page content code display portion 860 is provided in which the code for particular Web page content is displayed. A user may select portions of the Web page content to be a block of Web page content using a user interface, such as a mouse and associated displayed cursor.

For example, using a mouse, a user may highlight a portion of the Web page content code to be a block of Web page content. The user may then select one or more tool interfaces 810-850 for associating a block level caching property to be applied to the highlighted portion of Web page content code. The selection of one or more tool interfaces 810-850 may result in a subsequent graphical user interface window 870 being displayed for entry of particular values to be associated with the selected block level caching property. For example, an expiration time tool interface 820 may be used to generate a block level caching meta tag to be inserted into the Web page content code and the window 870 may be used to allow a user to input the expiration time period value to be associated with the expiration time meta tag.

The user may repeatedly highlight portions of Web page content and select tool interfaces to apply various global and/or block level caching properties to various blocks of the Web page content. Once the user is satisfied with the caching properties that have been applied to the Web page content code, the user may select a “save” interface tool 880 for saving a modified version of the Web page content code in which meta tags and corresponding caching property values are inserted in accordance with the user's selections using the graphical user interface. In this way, Web page content code is generated having global and/or block level caching properties inserted therein.

It should be appreciated that FIG. 8 is only exemplary and many other types of interfaces may be utilized with the present invention without departing from the spirit and scope of the present invention. For example, other tool interfaces other than those shown in FIG. 8 may be used in addition to, or in replacement of, those depicted. Moreover, various pull down menus, popup menus, or other known graphical user interface mechanisms may be used as part of the graphical user interface of FIG. 8 without departing from the spirit and scope of the present invention.

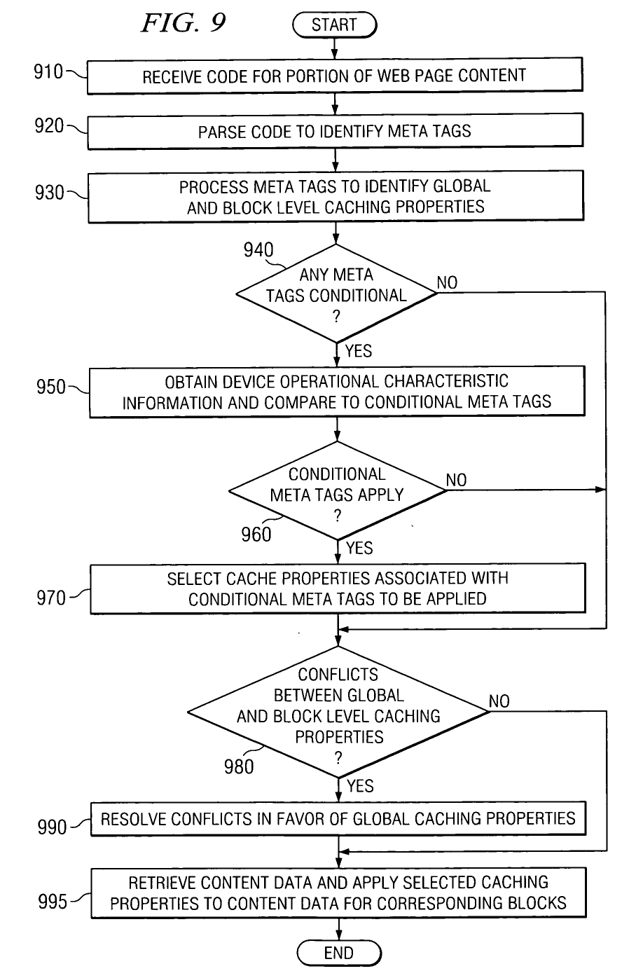

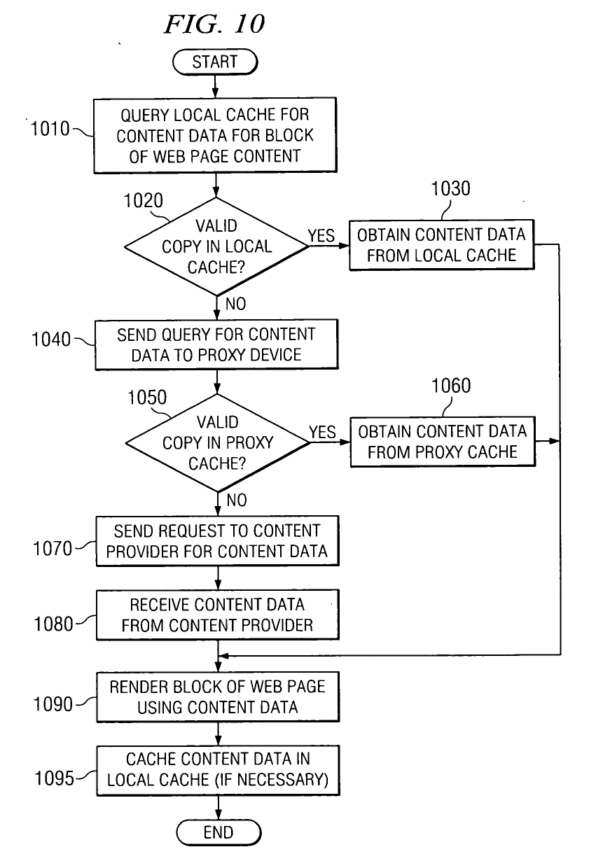

FIGS. 9 and 10 are flowcharts outlining exemplary operations of the present invention. It will be understood that each block, and combination of blocks, of the flowchart illustration in FIGS. 9 and 10 can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

FIG. 9 is a flowchart outlining an exemplary operation of the present invention when caching a block of Web page content. The operations shown in FIG. 8 may be performed, for example, at a client device, a proxy device, or the like.

As shown in FIG. 9, the operation starts by receiving code for a portion of Web page content (step 910). The code is parsed to identify meta tags within the code (step 920). The meta tags are then processed to identify global and block level caching properties for the blocks of Web page content within the portion of Web page content (step 930). A determination is made as to whether any of the meta tags have conditional requirements (step 940).

If so, information regarding operational characteristics of the present computing device that is processing the code for the portion of Web page content is retrieved (step 950). This information may be obtained, for example, from a configuration file, a performance monitoring application, or the like. The operational characteristic information is then compared to the conditional requirement for the meta tags having conditional requirements. A determination is made as to whether the corresponding caching property is to be applied, for each meta tag having a conditional requirement, based on the comparison (step 960). If so, then the corresponding caching property is selected for use in caching the associated block of Web page content (step 970).

Thereafter, or if there are no conditional requirement based meta tags, a determination is made as to whether there are any conflicts between global and block level caching properties (step 980). If so, then these conflicts are resolved in favor of the global caching properties such that the global caching properties are applied to the blocks of Web page content having the conflicting block level caching properties (step 990). Thereafter, or if there are no conflicts, the content data for the blocks of Web page content are retrieved and the various caching properties for each block of Web page content in the portion of Web page content are applied to content data for the corresponding blocks (step 995). The operation then ends.

FIG. 10 is a flowchart outlining an exemplary operation of the present invention when rendering a block of Web page content on a client computing device. It should be appreciated that the operation outlined in FIG. 10 is for one block of Web page content. The operation may be repeated for each block of Web page content required to render the requested Web page.

As shown in FIG. 10, the operation starts by querying a local client device cache for the content data for the block of Web page content (step 1010). A determination is made as to whether a valid copy of the content data is present in the local cache (step 1020). If so, then the content data is retrieved and used by the client device to render that block of the Web page content on the client device (step 1030).

If the content data is not present in the local cache of the client device, a query is sent to a proxy device to request the content data from the proxy device's cache (step 1040). A determination is made as to whether a valid copy of the content data is present in the proxy device's cache (step 1050). If so, then the content data is sent to the client device where a copy is placed in the local cache and the content data is used to render the block of Web page content on the client device (step 1060). It should be appreciated that, in storing a copy of the content data in the local cache, the caching properties specified in the code of the Web page will ensure consistency between the client device and the proxy device caches since expiration times are based on the time when the content data was transmitted by the content providers.

If the proxy device's cache does not have a valid copy of the content data for the block of Web page content, then a request is generated and sent to the content provider that provides the content data for the block of Web page content (step 1070). Typically, the code of the Web page for the block will identify the content provider, such as by network address, URL, or the like, and this may be used to send the request for the content data. Upon receiving the content data from the content provider (step 1080), the content data is used to render the block of Web page content (step 1090) and a copy of the content data is stored in a local cache in the manner outlined above in FIG. 9 (step 1095). The operation then terminates.

Thus, the present invention provides mechanisms for controlling the caching of blocks of Web page content in client side caches that may be part of a client device, proxy device, or the like. The present invention further provides mechanisms for setting forth conditional requirements for the application of caching properties based on client side device operational characteristics. Moreover, the present invention provides a mechanism for defining global and block level caching properties and resolving conflicts between such caching properties. Furthermore, the present invention provides mechanisms for building a Web page from content data obtained from various client side caches and a server side content provider based on content data stored in these caches in accordance with caching properties specified in the code of the blocks of Web page content.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a client side data processing system, for processing a portion of a Web page, comprising:
receiving code for a portion of a first Web page, wherein the code breaks the portion of the first Web page into blocks of Web page content, and wherein one or more of the blocks of Web page content have associated caching properties identified in the code;
parsing the code for the portion of the first Web page to identify the blocks of Web page content and their associated caching properties; and
caching, in a client side data processing system cache, content data corresponding to the blocks of Web page content based on the associated caching properties, wherein at least two blocks of Web page content have different caching properties, and wherein at least two portions of content data corresponding to the at least two blocks of Web page content are cached using the different caching properties.

2. The method of claim 1, further comprising:
receiving a request to retrieve a second Web page, different from the first Web page, wherein a first block of Web page content in the second Web page is the same as a second block of Web page content in the first Web page;
determining if a first portion of content data, corresponding to the first block of Web page content in the second Web page that is the same as the second block of Web page content in the first Web page, is present in the client side data processing system cache;
retrieving the first portion of content data from the client side data processing system cache if the first portion of content data is present in the client side data processing system cache; and
rendering the second Web page using the first portion of content data retrieved from the client side data processing system cache.

3. The method of claim 2, further comprising:
determining if the first portion of content data is valid in the client side data processing system cache;
requesting the first portion of content data from a source computing device if the first portion of content data is not present in the client side data processing system cache or is not valid in the client side data processing system cache; and
rendering the second Web page on a client device using the first portion of content data requested from the source computing device.

4. The method of claim 2, wherein the first Web page has block level caching enabled, and wherein the second Web page does not have block level caching enabled.

5. The method of claim 2, wherein the client side data processing system cache is a local cache of a client device.

6. The method of claim 5, further comprising:
determining if the first portion of content data is present in a client side proxy device coupled to the client device if the first portion of content data is not present in the local cache of the client device;
retrieving the first portion of content data from the client side proxy device if the first portion of content data is present in the client side proxy device; and
rendering the second Web page on the client device using the first portion of content data retrieved from the client side proxy device.

7. The method of claim 2, wherein the client side data processing system cache is a cache of a proxy device coupled to a client device that originated a request for the first Web page.

8. The method of claim 1, wherein the associated caching properties has a conditional requirement that identifies an operational characteristic that is required before the caching property is applied to content data for the corresponding block of Web page content.

9. The method of claim 2, further comprising:
retrieving operational characteristic information for the client side data processing system;
comparing the operational characteristic information to the conditional requirement; and
determining if the caching property is to be applied to content data for the corresponding block of Web page content based on results of the comparison.

10. The method of claim 1, wherein the associated caching properties are provided in meta tags within the code of the portion of the Web page.

11. The method of claim 2, wherein the request to retrieve the second Web page originates from a different client device than a client device that requested the first Web page.

12. A computer program product comprising a computer usable medium having a computer readable program, wherein the computer readable program, when executed on a computer, causes the computer to:
receive code for a portion of a first Web page, wherein the code breaks the portion of the first Web page into blocks of Web page content, and wherein one or more of the blocks of Web page content have associated caching properties identified in the code;
parse the code for the portion of the first Web page to identify the blocks of Web page content and their associated caching properties; and
cache, in a client side data processing system cache, content data corresponding to the blocks of Web page content based on the associated caching properties, wherein at least two blocks of Web page content have different caching properties, and wherein at least two portions of content data corresponding to the at least two blocks of Web page content are cached using the different caching properties.

13. The computer program product of claim 12, wherein the computer readable program further causes the computer to:
receive a request to retrieve a second Web page, different from the first Web page, wherein a first block of Web page content in the second Web page is the same as a second block of Web page content in the first Web page;
determine if a first portion of content data, corresponding to the first block of Web page content in the second Web page that is the same as the second block of Web page content in the first Web page, is present in the client side data processing system cache;
retrieve the first portion of content data from the client side data processing system cache if the first portion of content data is present in the client side data processing system cache; and
render the second Web page using the first portion of content data retrieved from the client side data processing system cache.

14. The computer program product of claim 13, wherein the computer readable program further causes the computer to:
determine if the first portion of content data is valid in the client side data processing system cache;
request the first portion of content data from a source computing device if the first portion of content data is not present in the client side data processing system cache or is not valid in the client side data processing system cache; and
render the second Web page on a client device using the first portion of content data requested from the source computing device.

15. The computer program product of claim 13, wherein the first Web page has block level caching enabled, and wherein the second Web page does not have block level caching enabled.

16. The computer program product of claim 13, wherein the client side data processing system cache is a local cache of a client device.

17. The computer program product of claim 16, wherein the computer readable program further causes the computer to:
determine if the first portion of content data is present in a client side proxy device coupled to the client device if the first portion of content data is not present in the local cache of the client device;
retrieve the first portion of content data from the client side proxy device if the first portion of content data is present in the client side proxy device; and
render the second Web page on the client device using the first portion of content data retrieved from the client side proxy device.

18. The computer program product of claim 12, wherein the associated caching properties has a conditional requirement that identifies an operational characteristic that is required before the caching property is applied to content data for the corresponding block of Web page content.

19. The computer program product of claim 13, wherein the computer readable program further causes the computer to:
retrieve operational characteristic information for the client side data processing system;
compare the operational characteristic information to the conditional requirement; and
determine if the caching property is to be applied to content data for the corresponding block of Web page content based on results of the comparison.

20. An apparatus, comprising:
a processor;
a memory coupled to the processor; and
a cache storage coupled to the processor, wherein the memory contains instructions which, when executed by the processor, causes the processor to:
receive code for a portion of a first Web page, wherein the code breaks the portion of the first Web page into blocks of Web page content, and wherein one or more of the blocks of Web page content have associated caching properties identified in the code;
parse the code for the portion of the first Web page to identify the blocks of Web page content and their associated caching properties; and
cache, in the cache storage, content data corresponding to the blocks of Web page content based on the associated caching properties, wherein at least two blocks of Web page content have different caching properties, and wherein at least two portions of content data corresponding to the at least two blocks of Web page content are cached using the different caching properties.
